(19) United States
(12) Patent Application Publication
(10) Pub. No.: US 2005/0120123 A1
(43) Pub. Date: Jun. 2, 2005

(54) Digital item adaptation negotiation mechanism

(76) Inventors: Zhongyang Huang, Singapore (SG); Sheng Mei Shen, Singapore (SG); Ming Ji, Singapore (SG); Takanori Senoh, Hirakata-shi (JP)

Correspondence Address: GREENBLUM & BERNSTEIN, P.L.C., 1950 ROLAND CLARKE PLACE, RESTON, VA, 20191, US

(21) Appl. No.: 10/498,020

(22) PCT Filed: Jul. 7, 2003
(86) PCT No.: PCT/JP03/08578

(30) Foreign Application Priority Data
Jul. 12, 2002 (JP) 2002-204286

(51) Int. Cl. G06F 15/16; H04N 7/167

(52) U.S. Cl. 709/231; 709/228; 380/217

(57) ABSTRACT

The present invention relates to digital item adaptation, especially MPEG-21 Digital Item Adaptation (DIA) which requires negotiation between different MPEG-21 peers. Advertisements metadata is defined to hold Digital Item Adaptation descriptions, such as Usage Environment description, BSDL description, XDI description, as well as MPEG-7 Media description in its descriptions element. With that, a generic DIA negotiation mechanism (protocol) using some XML schema based messages for DIA description transmission/exchange/update is defined. A generic and higher-level DIA Negotiation messages is also defined, which is independent from any network protocol, so that descriptions for Digital Item Adaptation can be directly included in the defined messages for registering, transmitting and updating to fulfil DIA description negotiation in those applications that is involved in digital item adaptation.

### TECHNICAL FIELD

The present invention relates to digital item adaptation, especially MPEG-21 Digital Item Adaptation (DIA) which requires negotiation between different MPEG-21 peers.

### BACKGROUND ART

Digital Item Adaptation (DIA) is a newly defined MPEG-21 part to specify description tools for the adaptation of Digital Items. Its main focus is “terminals and networks”, and the overall goal of the DIA is to achieve interoperable transparent access to advanced multimedia content by shielding Users from network and terminal installation, management and implementation issues. This will enable the provision of network and terminal resources on demand to form user communities where multimedia content can be created and shared, always with the agreed/contracted quality, reliability and flexibility, allowing the multimedia applications to connect diverse sets of Users.

Current DIA description has defined Usage Environment descriptor tools which specify tools for describing User Characteristics, Terminal Capabilities, Network Characteristics and Natural Environment Characteristics, Session Mobility XDI (Context Digital Item) description tool, BSDL (Bitstream Syntax Description Language) description. All these descriptions are necessary tools for Digital Item configuration in Client or Server side.

To make the content adaptation practical, the transmission and negotiation of DIA description between peers is highly required to define in an interoperable way. The negotiation mechanism and protocol need to define to help delivery of the multimedia resource to different terminals. There are some useful sceneries where data adaptation is required, such as one-way broadcasting application to different terminals, interactive two-way application for content adaptation, real-time streaming adaptation to different network, etc. Over there DIA descriptions for terminals, network, as well as user preference have to exchange and negotiate any time once they are required to do so. A DIA negotiation mechanism should be defined to facilitate the communication between peers like terminal, server, gateway, proxy, etc, in order to transmit DIA description and update DIA description in real time. By following MPEG-21 DIA description and as well as the set of MPEG-21 negotiation mechanism to be defined here a universal multimedia framework could be set up, which can handle different multimedia terminal, network, and usage environment with content adaptation.

This invention is to try to solve the following problems:

The DIA description can be exchanged, updated, and transmitted between any multimedia terminals and peers which is running on different physical machines with a variety of operating systems, and working in varied security, application, tools environments, but the negotiation is build in a high-level basis.

No matter what network protocol a terminal and a peer use, the negotiation for DIA description between peers is conducting independently to achieve digital item adaptation effectively and seamlessly.

Digital item will be adapted to different terminals, network, and users dynamically by implementing the negotiation mechanism in both involved peers.

### DISCLOSURE OF INVENTION

In a first aspect of the invention, provided is means to define the place for Advertisement Metadata using XML schema to include the MPEG-21 DIA description and several other generic messages for peer resolver, peer discovery, channel binding and endpoint routing. There are used as high-level protocol definition to exchange or update the DIA description information using peer discovery based on end-to-end peer connection.

More specifically, the method is provided for defining negotiation mechanism for digital Item adaptation (DIA). The method includes: creating MPEG-21 DIA description including at least one of Usage Environment, XDI (Context Digital Item), and BSDL (Bitstream Syntax Description Language) description based on standardized DIA description schema for peers which are MPEG-21 compatible terminals; placing the DIA description in the appropriate place to be used for exchanging, transmitting, or updating in negotiation protocol; specifying and defining some generic Protocol Message Schemas to implement functions of generic protocols; and exchanging, updating or transmitting the DIA description using the defined protocols.

The above method may include specifying and defining a flexible Advertisement Metadata Description Schema to describe various types of resources, including at least one of peer, peer domain, and channel; and Incorporating the DIA description into the Advertisement Metadata. In this case, the method may further include implementing the Advertisement Metadata Description Schema parser to interpret the Advertisement Metadata Description in the peers.

The above method may include building a connection of the peers that need exchange, transmit, or update the DIA description in the peer domain by building a channel by using Channel Binding Protocol, routing the Protocol Messages by using Endpoint Routing Protocol, and knowing the peers each other by using Peer Resolver Protocol.

The above method may include exchanging, updating or transmitting the DIA description by enabling the essential discovery message infrastructure based on Peer Discovery Protocol to query and response Advertisement Metadata including the DIA descriptions.

In the method of the first aspect, the specifying and defining generic Protocol Message Schemas may include implementing the message schema parser in all peers that involved in implementing all protocols.

In a second aspect of the invention, provided is means to define the generic high-level DIA negotiation messages which are bound to various network protocols and carry the MPEG-21 DIA description to register, transmit, or update the DIA description information based on base network connection.

More specifically, a method is provided for defining negotiation mechanism for Digital Item Adaptation (DIA). The method include: building a connection between peers that need DIA negotiation based on generic high-level peer-to-peer protocols and real network protocols, the peers being MPEG-21 compatible terminals; creating MPEG-21 DIA description including at least one of Usage Environment, XDI (Context Digital Item), and BSDL (Bitstream Syntax Description Language) description based on standardized DIA description schema for peers; specifying and defining generic and essential DIA negotiation messages schema which includes the DIA description and DIA description element, for implementing the negotiation mechanism; and registering, transmitting or updating the DIA description with the DIA negotiation messages between the peers that need DIA negotiation.

The above method may include specifying the DIA description as Reference using “Reference” to point to the entity of the DIA description which is placed in the World Wide Web, or specifying the DIA description as message payload using “DIADescriptionData” under DIADescription element.

The above method may include building a registering message for a first peer with a message ID of the first peer, when the first peer wants to transmit or update current DIA descriptions to a second peer; sending the registering message to the second peer; and sending, from the second peer to the first peer, the response message with the same message ID and message type, and “Response” information containing “True” which means the second peer is ready to receive DIA description from the first peer, or “False” which means the second peer rejects to receive the DIA description from the first peer by any reason.

The above method may include building a transmitting message for a first peer with a message ID of the first peer to transmit the current DIA descriptions to a second peer, sending the transmitting message to the second peer, and sending, from the second peer to the first peer, the response message with the same message ID and message type, and “Response” information containing “True” which means successfully receiving of the transmitted DIA description from the first peer to the second peer, or “False” which means unsuccessfully receiving of the transmitted DIA description from the first peer to the second peer by any reason.

The above method may include building an updating message for a first peer with a message ID of the first peer to update the current DIA descriptions to a second peer, sending the updating message to the second peer, and sending, from the second peer to the first peer, the response message with the same message ID and message type, and “Response” information containing “True” which means successfully receiving of the updating DIA description from the first peer to the second peer, or “False” which means unsuccessfully receiving of the updating DIA description from the first peer to the second peer by any reason.

In the method of the second aspect, the specifying and defining the generic and essential DIA negotiation messages schema may include implementing the DIA negotiation message schema parser in all peers that involved in exchanging the DIA descriptions.

Using the first means, based on the defined Advertisement Metadata XML schema, the description of the user characteristics, terminal capability, the network characteristics, natural environment characteristics, the XDI description, and BSDL description can be transmitted, exchanged, or updated by using the defined negotiation protocol. It is further elaborated in Section 1 of “Best Mode for Carrying Out the Invention”.

Using the second means, based on the defined generic negotiation messages, the description of the user characteristics, terminal capability, the network characteristics, natural environment characteristics, the XDI description, and BSDL description can be registered, transmitted, and updated. It is further elaborated in Section 2 of “Best Mode for Carrying Out the Invention”.

A MPEG-21 peer is built by implementing high-level communication messages which is bound to various network protocols. A message parser is also required to be implemented in peers.

This invention is to design negotiation mechanism with defined messages to use for content adaptation to various types of devices in the market, and can solve the problem of designing the standard way to be used in MPEG-21 Digital Item Adaptation negotiation, by providing all high-level generic messages for protocol including defined Advertisement Metadata.

### BRIEF DESCRIPTION OF DRAWINGS

FIG. 1 shows Multimedia distribution network with DIA negotiation.

FIG. 2 shows DiscoveryQuery XML message example.

FIG. 3 shows DiscoveryResponse XML message with update DIA example.

FIG. 4 shows MPEG-21 Generic DIA Messages Layer for Negotiation.

FIG. 5 shows MPEG-21 Generic DIA Negotiation Messages Flowchart between Peers.

FIG. 6 shows a block diagram of the syntax and semantics of the DIA description Negotiation messages Schema.

### BEST MODE FOR CARRYING OUT THE INVENTION

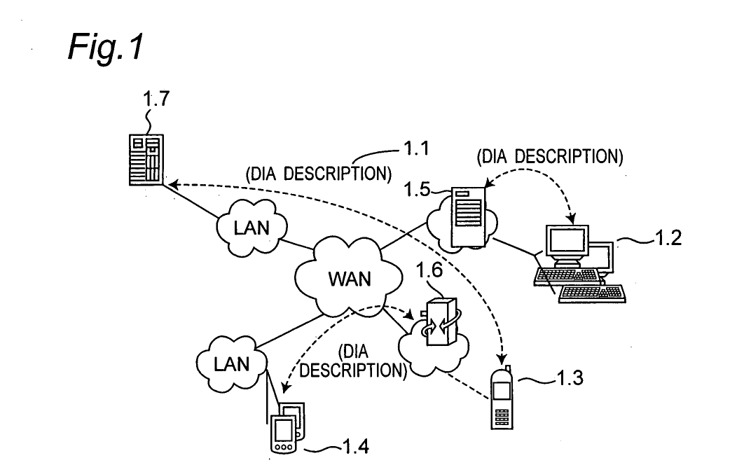

The prior art is illustrated in FIG. 1 to show that the MPEG-21 DIA description (module 1.1) need to transmit between any connected devices (module 1.2, 1.3, 1.4) in the network ranging from wireless cell phones and PDAs to PCs and servers/gateway/proxy (module 1.5, 1.6, 1.7).

Currently there is no way for Digital Media Server in module 1.7 to deliver the same content with the same format to different kinds of devices here. Even such devices can be connected in a peer-to-peer manner, if there is no negotiation mechanism to be defined, it is still impossible to adapt the same content to different kinds of devices according to their different capabilities and even user preference. This will limit the content adaptation to narrow range of media access applications.

1. Negotiation of DIA Description Based on Generic Protocols

In this section, we try to present a generic peer-to-peer negotiation protocol to exchange the DIA description effectively that is required to adapt content to a terminal under particular network condition and user preference. This protocol should fit well into the current and future networking protocols being developed.

It should note that automatic/manual configuration of DIA description at client side is not the item that need to be discussed in this invention. For example, the session of CDI (Content Digital Item) can be reconstructed by the received related XDI (Context Digital Item) for session mobility in whatever way that is described in the invention. But when the XDI description is put into the DIA negotiation metadata based on protocols defined in this invention, the XDI requesting and transferring between terminal and server will become practical and session mobility of Digital Item can be implemented.

Some terminologies are briefly explained here (the peer concept can also be used in Section 2):

Peer: A peer is any networked device that implements the protocols. Each peer operates independently and asynchronously of all other peers. Some peers may have more dependencies with other peers due to special relationships (gateways or routers). Peers can discover each other on the network to form peer domains. Peers may publish resources to other peers. A peer endpoint is a URI that uniquely identify a peer network interface. Peer endpoints are used by peers to establish direct point-to-point connection between two peers. A peer may have to use one or more intermediary peers to route a message to another peer. Each peer is uniquely identified by a unique Peer ID.

Peer Domain: PeerDomains are a collection of peers that have some common interests. PeerDomains may also be statically predefined. Peers self-organize into Peer Domains. Each peer domain is also identified by a unique PeerDomain ID. The protocols describe how a peer may publish, discover, join, and monitor PeerDomains.

Channels: Channels are virtual communication pipes used to send and receive messages between services or applications over endpoints. Channels provide a network abstraction over the peer endpoint transport. Peer endpoints correspond to the available peer network interfaces that can be used to send and receive data from another peer. Channels provide the illusion of a virtual in and out mailbox that is independent of any single peer location, and network topology. A channel can offer point-to point mode of communication.

Messages: The information transmitted using channels and between endpoints is packaged as messages. The protocols are specified as a set of XML messages exchanged between peers. The use of XML messages to define protocols allows many different kinds of peers to participate in a protocol. Each peer is free to implement the protocol in a manner best suited to its abilities and role.

Advertisements metadata: All resources, such as peers, peerdomains, channels and services are represented by advertisements metadata.

DIA metadata: All Digital Item Adaptation descriptions, such as Usage Environment description, BSDL description, XDI (only DIA description wrapped in a DID), as well as MPEG-7 Media description are represented by DIA metadata in Advertisement metadata descriptions.

ID: Within the defined protocols there are a number of entities (peers, peerdomains, pipes and contents) that need to be uniquely identifiable. An ID uniquely identifies an entity and serves as a canonical way of referring to that entity. URIs are used for the expression of IDs.

The negotiation protocol defined in MPEG-21 consists of a set of open protocols and targets on peer-to-peer communication transferring DIA metadata with peers across public networks in a generic way. The peers defined in the protocol create a virtual network where any peer can interact with other peers and resources directly even when some of the peers are behind firewalls or are on different network transports. The protocol defined should meet the requirement of interoperability that means interconnected peers must easily communicate with each other across different systems and communities. Also the peer-to-peer network should support different programming language, operating system and networking platform implemented on top of TCP/IP, HTTP, Bluetooth, HomePNA, and many other protocols. Also it can support broadest digital devices including CE, PDA, appliance, network routers, PC, server and storage system, etc.

The protocols are a set of mechanisms that are specifically designed for peer-to-peer network computing. Using these mechanisms, peers can cooperate to form self-organized and self-configured peer domains independently of their positions in the network, and without the need of a centralized management infrastructure.

Peers use the protocols to inform their DIA metadata and to discover network resources (services, channels, etc.) available from other peers. Peers form and join peer domains to create special relationships. Peers cooperate to route messages allowing for full peer connectivity. All the protocols allow peers to communicate without needing to understand or manage the potentially complex and dynamic network topologies. The protocols allow peers to dynamically route messages across multiple network hops to any destination in the network. Each message carries with it either a complete or partial ordered list of gateway peers through which the message might be routed. If a route information is incorrect, the intermediate peer can assist in dynamically finding a new route.

The protocols are multiple mechanisms that work together to allow the discovery, organization, monitoring and communication between peers:
The mechanism by which a peer can send a query to one or more peers, and receive a response (or multiple responses) to the query. It implements a query/response protocol. The response message is matched to the query via a unique ID included in the message body. When a peer is discovered, a query can be sent to that peer.
The mechanism by which a peer can advertise its own resources, and discover the resources from other peers (peer domains, channels and additional peers). Every peer resource is described and published using an advertisement metadata. The metadata are represented as XML documents.
The mechanism by which a peer can establish a virtual communication channel between one or more peers. Channels provide the foundation communication mechanism between peers.
The mechanism by which a peer can discover a route used to send a message to another peer. If a peer A wants to send a message to peer C, and there is no direct route between A and C, then peer A needs to find the intermediary peer(s) to route the message to C. All of these protocols are implemented using a common messaging layer.
   1.1 XML Schema based Messages for Protocols

Peer Resolver: The Peer Resolver permits the distribution of generic queries to one or multiple handlers within the domain and match them with responses. Each query is addressed to a specific handler name. This handler name defines the particular semantics of the query and its responses, but is not associated with any specific peer. A given query may be received by any number of peers in the domain, and processed according to the handler name if such a handler name is defined on that peer. The intent of Peer Resolver is to provide the essential generic query/response infrastructure for building high-level resolver services. In many situations, a higher-level service may have a better knowledge of the domain topology.

QueryMessage

<xs:complexType name=“ResolverQuery”>

<xs:sequence>

<xs:element name=“SrcPeerID” type=“xs:anyURI”/>
<xs:element name=“HandlerName” type=“xs:string”/>
<xs:element name=“QueryID” type=“xs:string”/>
<xs:element name=“Query” type=“xs:anyType”/>

</xs:sequence>

</xs:complexType>

HandlerName: A string that specifies how this query should be handled.

SrcPeerID: The ID of the peer originating the query.

QueryID: Query ID. This ID should be included in the responses to this query.

Query: query structure.

ResponseMessage

<xs:complexType name=“ResolverResponse”>

<xs:sequence>

<xs:element name=“HandlerName” type=“xs:string”/>
<xs:element name=“QueryID” type=“xs:string”/>
<xs:element name=“Response” type=“xs:anyType”/>

</xs:sequence>

</xs:complexType>

HandlerName: specifies how to handle the response.

QueryID: The ID of the query to which this responds.

Response: response structure.

Endpoint Routing: The connections of defined protocol in the network may be transient, and message routing is nondeterministic. The Endpoint Routing here defines a set of request/query messages that is processed by a routing service to help a peer route message to its destination. When a peer is asked to send a message to a given peer endpoint address, it looks in its local cache if it has a route to this peer. If it does not find a route, it sends a route resolver query message to its available peer routers asking for a route information. Peers routers offer the ability to cache route information, as well as bridging different physical or logical networks. When a peer router receives a route query, if it knows the destination, it answers the query by returning the route information as an enumeration of hops. The message can be sent to the first router and that router will use the route information to route the message to the destination peer. At any point the routing information may be obsolete requiring the current router to find a new route. Endpoint Route defined here intends to provide the hook necessary for user defined routing services to manipulate and update the route. Two communicating peers may need to use a peer router to route messages depending on their network location. Peer routers will typically cache route information. Any peer can query a peer router for route information. Any peer in a peer domain may become a peer router.

QueryMessage

<xs:complexType name=“EndpointRouteQuery”>

<xs:sequence>

<xs:element name=“DestPeerID” type=“xs:anyURI”/>
<xs:element name=“Cached” type=“xs:boolean”/>

</xs:sequence>

</xs:complexType>

DestPeerID: The ID of the destination peer.

Cached: True when the reply can be a cached reply; False when the reply must not come from a cache.

AnswerMessage

<xs:complexType name=“EndpointRouteAnswer”>

<xs:sequence>

<xs:element name=“DestPeerID” type=“xs:anyURI”/>
<xs:element name=“RoutPeerID” type=“xs:anyURI”/>
<xs:element name=“AdvMetadata” type=“xs:anyType”/>
<xs:element name=“GatewayID” type=“xs:anyURI”

minOccurs=“0” maxOccurs=“unbounded”/>

</xs:sequence>

</xs:complexType>

DestPeerID: The ID of the destination peer.

RoutPeerID: The peer ID of the router who knows a route to destination peer.

AdvMetadata: Advertisement metadata of the routing peer.

GatewayID: sequence IDs of gateway.

Channel Binding: The Channel Binding is used by applications and services in order to communicate with other peers. A channel is a virtual channel between two endpoints. The Channel Binding can use a variety of transport protocols, such as the HTTP, TCP/IP or TLS Transport. A channel can be viewed as an abstract named message queue, supporting create, open/resolve (bind), close (unbind), delete, send, and receive operations. Multiple binding query messages may be sent. None, one or multiple responses may be received.

QueryMessage

<xs:complexType name=“ChannelResolverQuery”>

<xs:sequence>

<xs:element name=“ChannelID” type=“xs:anyURI”/>
<xs:element name=“Cached” type=“xs:boolean”

minOccurs=“0”/>

<xs:element name=“PeerID” type=“xs:anyURI”

minOccurs=“0”/>

</xs:sequence>

</xs:complexType>

ChannelID: The Channel ID which is being resolved.

Cached: True when the reply can be a cached reply. False if the answer must not come from the cache. The requestor may ask that the information be not obtained from the cache. This is to obtain the most up-to-date information from a peer to address stale connection.

PeerID: gives a peer ID. It specifies the Peer ID of the only peer from which responses will be expected. Responses from all other peers will be ignored. This does not guarantee a response to the channel binding request will be made by the peer.

ResponseMessage

<xs:complexType name=“ChannelResolverResponse”>

<xs:sequence>

<xs:element name=“ChannelID” type=“xs:anyURI”/>
<xs:element name=“Found” type=“xs:boolean”

minOccurs=“0”/>

<xs:element name=“PeerAdvMetadata” type=“xs:anyType”

minOccurs=“0”/>

</xs:sequence>

</xs:complexType>

ChannelID: The Channel ID which is being resolved.

Found: Used to indicate if the Input Channel was found on the specified peer.

PeerAdvMetadata: Advertisements metadata of the peer which resolved the Input Channel.

Peer Discovery: The Peer Discovery is used to discover any published peer resource and also advertise its own resources. Resources are represented as advertisement metadata. The Peer Discovery enables a peer to find metadata in its domain. The intent is to provide the essential discovery infrastructure for building high-level discovery services. In many situations, discovery information is better known by a high-level service, because the service may have a better knowledge of the domain topology. The Peer Discovery provides a basic mechanism to discover advertisement metadata while providing hooks so high-level services and applications can participate in the discovery process.

QueryMessage

<xs:complexType name=“DiscoveryQuery”>

<xs:sequence>

<xs:element name=“Number” type=“xs:unsignedInt”/>
<xs:element name=“Attribute” type=“xs:string”/>
<xs:element name=“Value” type=“xs:string”/>
<xs:element name=“PeerAdvMetadata” type=“xs:anyType”

minOccurs=“0”/>

<xs:element name=“Update” type=“xs:boolean”/>

</xs:sequence>

</xs:complexType>

Number: specifies the maximum number of advertisements metadata that each responding peer may provide.

Attribute and Value: Only metadata containing an element of name Attribute and of value Value are eligible to be found.

PeerAdvMetadata: Advertisement metadata of the requesting peer. Update: indicate that if transferred DIA description in PeerAdvMetadata is just updated description (True) or the complete description (False).

ResponseMessage

<xs:complexType name=“DiscoveryResponse”>

<xs:sequence>

<xs:element name=“Number” type=“xs:unsignedInt”/>
<xs:element name=“Attribute” type=“xs:string”/>
<xs:element name=“Value” type=“xs:string”/>
<xs:element name=“PeerAdvMetadata” type=“xs:anyType”

minOccurs=“0”/>

<xs:element name=“Update” type=“xs:boolean”/>
<xs:element name=“Response” type=“xs:anyType”

maxOccurs=“unbounded”/>

</xs:sequence>

</xs:complexType>

Number: specifies the number of Response elements received.

Attribute and Value: reflect that of the DiscoveryQuery to which this is the response.

PeerAdvMetadata: Advertisement metadata of the respondent peer.

Update: indicate that if transferred DIA description in PeerAdvMetadata is just updated description (True) or the complete description (False).

Response: response structure.

1.2 XML Schema Based Metadata

Advertisement metadata which is presented in XML schema is used to describe the peers, peer domains, channels, media resource, services and many other types of resources. The DIA description intended to provide information necessary for adapting the Media Resource is placed in advertisement metadata here. The protocols to be defined depend on such key information, used to pass such metadata between peers.

The advertisement metadata description schema and their semantics are shown below:

| | |
|---|---|
| <xs:schema | xmlns:xs=“http://www.w3.org/2001/XMLSchema” |

elementFormDefault=“qualified” attributeFormDefault=“unqualified”>

<xs:element name=“AdvMetadata”>

<xs:annotation>

<xs:documentation>Describe all types of

resources</xs:documentation>

</xs:annotation>
<xs:complexType>

<xs:sequence>

<xs:element name=“Name” type=“xs:string”

minOccurs=“0”/>

<xs:element name=“PeerID” type=“xs:anyURI”

minOccurs=“0”/>

| | |
|---|---|
| <xs:element | name=“PeerDomainID” |

type=“xs:anyURI” minOccurs=“0”/>

<xs:element name=“ChannelID” type=“xs:anyURI”

minOccurs=“0”/>

<xs:element name=“Description” type=“xs:anyType”

minOccurs=“0”/>

<xs:element name=“Service” type=“xs:anyType”

minOccurs=“0”/>

</xs:sequence>

</xs:complexType>

</xs:element>

</xs:schema>

Name: This is an optional string that can be associated with a peer, a peer domain, a channel. The name is not required to be unique unless the name is obtained from a centralized naming service that guarantees name uniqueness.

PeerID: This is an element that uniquely identifies the peer.

PeerDomainID: This element provides the Peer Domain ID. Each peer domain has a unique ID.

ChannelID: This is an element that uniquely identifies the Channel.

Description: This is an optional anyType element that can be used to give detail DIA descriptions metadata.

Service: The element describes the association between a domain service denoted by its Class and arbitrary parameters designated. The Service section may also optionally contain an element meaning that this service is disabled. This element is used to convey a configuration choice made by the owner of the peer.

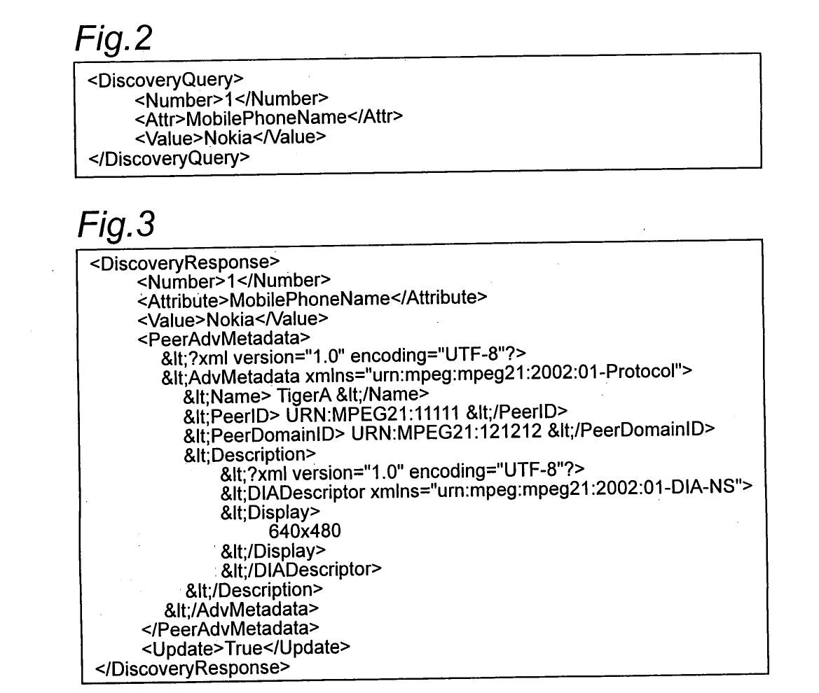

Finally, we try to show a DiscoveryQuery and DiscoveryResponse XML messages example with DIA description updating in FIGS. 2 and 3, respectively. The mobilephone clients and a digital multimedia server in the Internet in FIG. 1 have known each other and been set up an effective connection between them by sending Peer Resolver, Endpoint Router, Channel Binding messages through a wired and a wireless network. The server sends a Peer Discovery message to all mobilephones matched with “attribute” and “value” and tries to get their DIA updating responses, e.g. DIA “display” element update shown in FIG. 3.

2. General DIA Negotiation Messages Among Distributed Peers using XML Schema

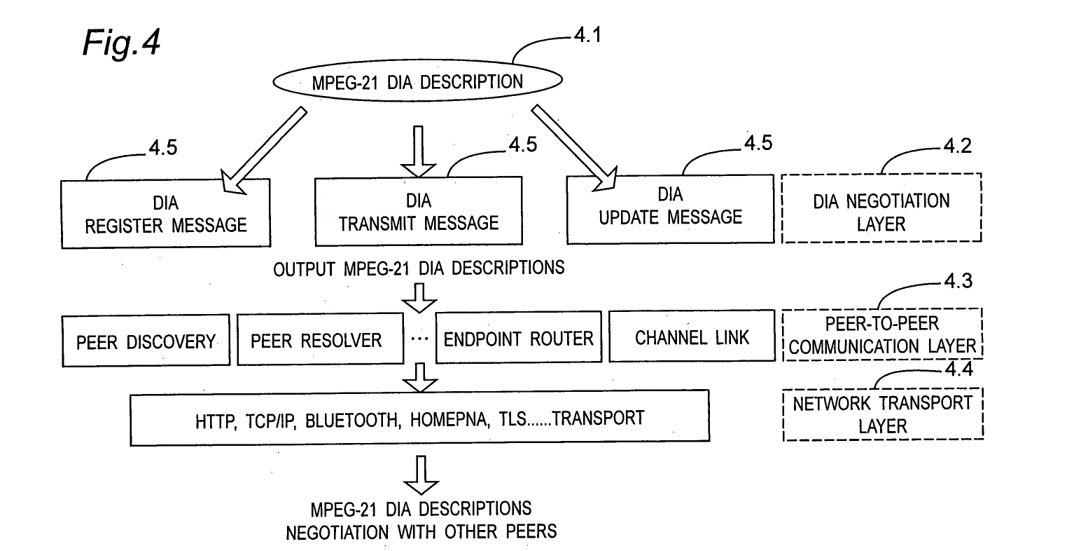

The DIA negotiation to be defined in MPEG-21 targets on peer-to-peer transferring DIA metadata across public networks in a generic way. An open network platform can be designed for peer-to-peer computing. A set of open protocols that allow any connected device on the network ranging from cell phones and wireless PDAs to PCs and servers/gateway/proxy to communicate and collaborate in a peer-to-peer manner could be defined, e.g. Peer Resolver, Endpoint Routing, Peer Discovery, and Channel Binding in Section 1. Another solution for DIA description negotiation in an interoperable way is to define some generic DIA description negotiation messages in the higher-level which carry the DIA description metadata. The Advertisement Metadata defined in Section 1.2 need not hold the DIA description metadata. All these negotiation messages can be designed on the up-layer of the defined generic protocols and/or normally existing lowest-layer physical network protocol such as HTTP/TCP/IP. This concept is shown in FIG. 4.

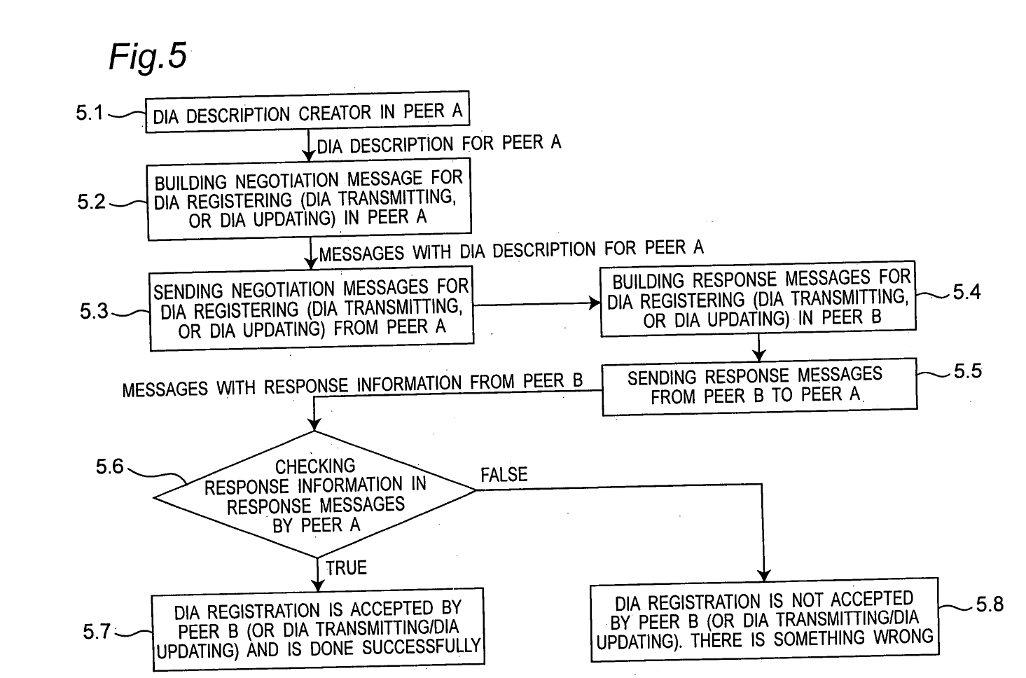

The module 4.1 is DIA description including Usage Environment, XDI (Context Digital Item), BSDL (Bitstream Syntax Description Language) description etc which can be accessed by URI or carried as payload (DIADescriptionData) in negotiation messages. The module 4.2, 4.3, 4.4 are separate layers for negotiation mechanism which define the messages for DIA negotiation, the protocols for peer-to-peer communication, and the physical network transport, respectively. The module 4.5 gives three generic messages (DIARegister, DIATransmit, and DIAUpdate) which carry the DIA description of module 4.1 in highest layer for DIA negotiation. The flowchart of the negotiation messages are also shown in FIG. 5.

Module 5.1 shows the creation MPEG-21 DIA description for Peer A including Usage Environment, XDI (Context Digital Item), BSDL (Bitstream Syntax Description Language) description based on standardized DIA description schema.

Module 5.2 shows that peer A builds a registering message (or transmitting or updating message) when Peer A wants to transmit or update current DIA descriptions to Peer B. The registering message is used to request registration of the DIA descriptions of one peer to the other peer. The transmitting message is used to transfer detail terminal specification for communication between peers. The updating message is used, when terminal information of one peer is changed, to notify the change in the terminal information from one peer to the other peer.

Module 5.3 shows that Peer A sends the registering (or transmitting or updating) message with the DIA description for Peer A, to Peer B.

Module 5.4 shows that Peer B builds response messages for the registering (or transmitting or updating) with “response” information to Peer A.

Module 5.5 shows that Peer B sends back the response messages for the registering (transmitting, or updating) with “response” information to Peer A.

Peer A checks the value included in the “response” information in the response messages to know whether the DIA description negotiation between Peers A and B is successful, which is shown in module 5.6. When “response” value is “true”, it indicates that Peer B accepts the registration from Peer A and it is ready to receive DIA description from Peer A for either new or updating DIA description of Peer A, as shown in module 5.7. Otherwise, when “response” value is “false”, it indicates that Peer B rejects the registration from Peer A and it does not want to receive DIA description from Peer A or it has problem to receive the new or updating DIA description, which is shown in module 5.8.

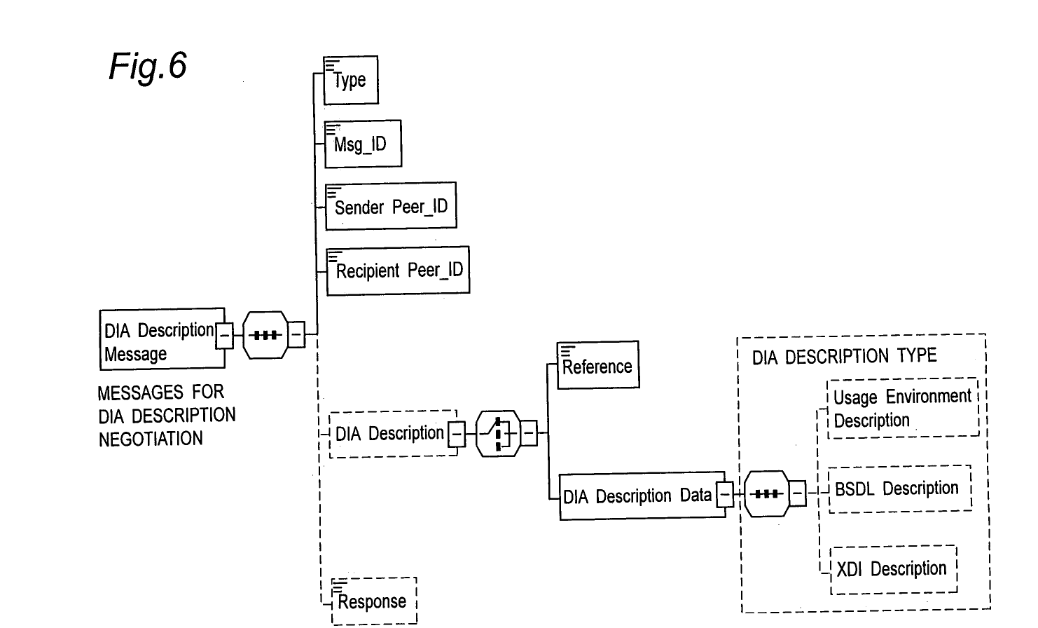

The syntax and semantics of the DIA description Negotiation messages Schema, illustrated in FIG. 6, are shown below.

<?xml version=“1.0” encoding=“UTF-8”?>

| | |
|---|---|
| <xs:schema | xmlns:xs=“http://www.w3.org/2001/XMLSchema” |

elementFormDefault=“qualified” attributeFormDefault=“unqualified”>

<xs:element name=“DIADescriptionMessage”>

<xs:annotation>

<xs:documentation>messages for DIA description

negotiation</xs:documentation>

</xs:annotation>
<xs:complexType>

<xs:sequence>

<xs:element name=“Type”>

<xs:simpleType>

<xs:restriction base=“xs:string”>

<xs:enumeration

value=“DIARegister”/>

<xs:enumeration

value=“DIATransmitting”/>

<xs:enumeration

value=“DIAUpdating”/>

</xs:restriction>

</xs:simpleType>

| </xs:element> | |
|---|---|
| <xs:element | name=“Msg_ID” |

type=“xs:nonNegativeInteger”/>

| <xs:element name=“SenderPeer_ID” type=“xs:ID”/> | |
|---|---|
| <xs:element | name=“RecipientPeer_ID” |

type=“xs:ID”/>

<xs:element name=“DIADescription”>

<xs:complexType>

<xs:choice>

<xs:element name=“Reference”

type=“xs:anyURI”/>

<xs:element

name=“DIADescriptionData” type=“DIADescriptionType”/>

</xs:choice>

</xs:complexType>

</xs:element>
<xs:element name=“Response” type=“xs:boolean”

minOccurs=“0”/>

</xs:sequence>

</xs:complexType>

</xs:element>
<xs:complexType name=“DIADescriptionType”>

<xs:sequence>

| | |
|---|---|
| <xs:element | name=“UsageEnvironmentDescription” |

minOccurs=“0”/>

<xs:element name=“BSDLDescription” minOccurs=“0”/>
<xs:element name=“XDIDescription” minOccurs=“0”/>

</xs:sequence>

</xs:complexType>

</xs:schema>

Type: indicates the DIA negotiation message type, such as “DIARegistering”, “DIATransmitting”, and “DIAUpdating”;
DIARegistering: message type used for registering the DIA description when the peer tries to transmit or update the current DIA descriptions;
DIATransmitting: message type used for transmitting the current peer DIA description;
DIAUpdating: message type used for updating the current peer DIA description;
Msg_ID: message identifier specified by the message originator. All messages sent in response to a message shall include the identifier of the original message;
SenderPeer_ID: indicates the peer ID of the originator of the message;
RecipientPeer_ID: indicates the peer ID of the intended recipient of the message;
DIADescription: all Digital Item Adaptation descriptions that need to be transmitted, exchanged or updated, such as Usage Environment description, BSDL description, XDI (DIA description for session mobility wrapped in a DID); DIA Description can be carried in the messages as payload “DIADescriptionData” or can use “Reference” to point to the entity of the DIA description which is placed in the WorldWideWeb.

Response: Used to carry the response messages which respond to the original incoming messages with the same “Msg_ID” and “Type”.

“True” indicates that the message sender agrees to receive DIA description after processing DIARegistering message in the case of DIARegistering; in the case of DIATransmitting, “True” indicates that the message sender receives the DIA description successfully; while in the case of DIAUpdating, “True” indicates that the message sender receives the updating DIA description successfully.

“False” indicates “not agree”, “something wrong to receive the DIA description”, “something wrong to receive the updating DIA description” in the above three cases. When “Response” element used, the “DIADescription” is not used.

Another means to solve the problem is provided by higher-level DIA messages for negotiation mechanism in a standard way.

Although the present invention has been described in connection with specified embodiments thereof, many other modifications, corrections and applications are apparent to those skilled in the art. Therefore, the present invention is not limited by the disclosure provided herein but limited only to the scope of the appended claims.

The present disclosure relates to subject matter contained in Japanese Patent Application No. 2002-204286, filed on Jul. 12, 2002, which is expressly incorporated herein by reference in its entirety.

1. A method of defining negotiation mechanism for digital Item adaptation (DIA), comprising:
creating MPEG-21 DIA description including at least one of Usage Environment, XDI (Context Digital Item), and BSDL (Bitstream Syntax Description Language) description based on standardized DIA description schema for peers which are MPEG-21 compatible terminals;
placing the DIA description in the appropriate place to be used for exchanging, transmitting, or updating in negotiation protocol;
specifying and defining some generic Protocol Message Schemas to implement functions of generic protocols; and
exchanging, updating or transmitting the DIA description using the defined protocols.

2. The method according to claim 1, further comprising:
specifying and defining a flexible Advertisement Metadata Description Schema to describe various types of resources, including at least one of peer, peer domain, and channel; and
Incorporating the DIA description into the Advertisement Metadata.

3. The method according to claim 2, further comprising implementing the Advertisement Metadata Description Schema parser to interpret the Advertisement Metadata Description in the peers.

4. The method according to claim 1, further comprising building a connection of the peers that need exchange, transmit, or update the DIA description in the peer domain by building a channel by using Channel Binding Protocol, routing the Protocol Messages by using Endpoint Routing Protocol, and knowing the peers each other by using Peer Resolver Protocol.

5. The method according to claim 1, further comprising exchanging, updating or transmitting the DIA description by enabling the essential discovery message infrastructure based on Peer Discovery Protocol to query and response Advertisement Metadata including the DIA descriptions.

6. The method according to claim 1, wherein the specifying and defining generic Protocol Message Schemas comprises implementing the message schema parser in all peers that involved in implementing all protocols.

7. A method of defining negotiation mechanism for Digital Item Adaptation (DIA), comprising:
building a connection between peers that need DIA negotiation based on generic high-level peer-to-peer protocols and real network protocols, the peers being MPEG-21 compatible terminals;
creating MPEG-21 DIA description including at least one of Usage Environment, XDI (Context Digital Item), and BSDL (Bitstream Syntax Description Language) description based on standardized DIA description schema for peers;
specifying and defining generic and essential DIA negotiation messages schema which includes the DIA description and DIA description element, for implementing the negotiation mechanism; and
registering, transmitting or updating the DIA description with the DIA negotiation messages between the peers that need DIA negotiation.

8. The method according to claim 7 further comprising specifying the DIA description as Reference using “Reference” to point to the entity of the DIA description which is placed in the World Wide Web, or specifying the DIA description as message payload using “DIADescriptionData” under DIADescription element.

9. The method according to claim 7 further comprising
building a registering message for a first peer with a message ID of the first peer, when the first peer wants to transmit or update current DIA descriptions to a second peer;
sending the registering message to the second peer; and
sending, from the second peer to the first peer, the response message with the same message ID and message type, and “Response” information containing “True” which means the second peer is ready to receive DIA description from the first peer, or “False” which means the second peer rejects to receive the DIA description from the first peer by any reason.

10. The method according to claim 7 further comprising
building a transmitting message for a first peer with a message ID of the first peer to transmit the current DIA descriptions to a second peer,
sending the transmitting message to the second peer, and
sending, from the second peer to the first peer, the response message with the same message ID and message type, and “Response” information containing “True” which means successfully receiving of the transmitted DIA description from the first peer to the second peer, or “False” which means unsuccessfully receiving of the transmitted DIA description from the first peer to the second peer by any reason.

11. The method according to claim 7 further comprising
building an updating message for a first peer with a message ID of the first peer to update the current DIA descriptions to a second peer,
sending the updating message to the second peer, and
sending, from the second peer to the first peer, the response message with the same message ID and message type, and “Response” information containing “True” which means successfully receiving of the updating DIA description from the first peer to the second peer, or “False” which means unsuccessfully receiving of the updating DIA description from the first peer to the second peer by any reason.

12. The method according to claim 7, wherein the specifying and defining the generic and essential DIA negotiation messages schema comprises implementing the DIA negotiation message schema parser in all peers that involved in exchanging the DIA descriptions.

13. The method according to claim 2, wherein the specifying and defining generic Protocol Message Schemas comprises implementing the message schema parser in all peers that involved in implementing all protocols.

14. The method according to claim 3, wherein the specifying and defining generic Protocol Message Schemas comprises implementing the message schema parser in all peers that involved in implementing all protocols.

15. The method according to claim 4, wherein the specifying and defining generic Protocol Message Schemas comprises implementing the message schema parser in all peers that involved in implementing all protocols.

16. The method according to claim 5, wherein the specifying and defining generic Protocol Message Schemas comprises implementing the message schema parser in all peers that involved in implementing all protocols.

17. The method according to claim 8, wherein the specifying and defining the generic and essential DIA negotiation messages schema comprises implementing the DIA negotiation message schema parser in all peers that involved in exchanging the DIA descriptions.

18. The method according to claim 9, wherein the specifying and defining the generic and essential DIA negotiation messages schema comprises implementing the DIA negotiation message schema parser in all peers that involved in exchanging the DIA descriptions.

19. The method according to claim 10, wherein the specifying and defining the generic and essential DIA negotiation messages schema comprises implementing the DIA negotiation message schema parser in all peers that involved in exchanging the DIA descriptions.

20. The method according to claim 11, wherein the specifying and defining the generic and essential DIA negotiation messages schema comprises implementing the DIA negotiation message schema parser in all peers that involved in exchanging the DIA descriptions.
